(19) United States
(12) Patent Application Publication
(10) Pub. No.: US 2014/0254496 A1
(43) Pub. Date: Sep. 11, 2014

(54) Methods and Devices for Allocating Resource Blocks in an LTE Network

(71) Applicant: ATC TECHNOLOGIES, LLC, Reston, VA (US)

(72) Inventor: Masoud Olfat, Great Falls, VA (US)

(73) Assignee: ATC Technologies, LLC, Reston, VA (US)

(21) Appl. No.: 13/788,031

(22) Filed: Mar. 7, 2013

(51) Int. Cl. H04W 72/04

(52) U.S. Cl. CPC H04W 72/04
USPC 370/329

(57) ABSTRACT

Resource blocks in a Long Term Evolution (LTE) network may be allocated by determining a maximum number of user equipments (UEs) in the LTE network that are permitted to transmit in a time period using a given resource block. This maximum number of UEs may be determined according to an upper limit on the overall transmission power in the LTE network for the given resource block. The given resource block may be allocated in the time period to up to the maximum number of UEs based on each UE's geographic location within the network. Related systems, methods, and devices are disclosed.

### FIELD OF THE INVENTION

Various embodiments described herein relate to wireless communications systems and methods, and more particularly to devices and methods for allocating resources in a Long Term Evolution (LTE) network.

### BACKGROUND OF THE INVENTION

Satellite wireless communications systems and methods are widely used for wireless communications. Satellite wireless communications systems and methods generally employ at least one space-based component, such as one or more satellites that are configured to wirelessly communicate with a plurality of user equipments (UEs).

A satellite wireless communications system or method may utilize a single antenna beam covering an entire area served by the system. Alternatively, in cellular satellite wireless communications systems and methods, multiple beams are provided, each of which can serve distinct geographical areas in the overall service region, to collectively serve an overall satellite footprint. Thus, a wireless architecture similar to that used in conventional terrestrial wireless systems and methods can be implemented in wireless satellite-based systems and methods. The satellite typically communicates with UEs over a bidirectional communications pathway, with wireless communication signals being communicated from the satellite to the UE over a downlink (DL) or forward link, and from the UE to the satellite over an uplink (UL) or return link. The overall design and operation of wireless systems and methods are well known to those having skill in the art, and need not be described further herein.

Terrestrial networks can enhance satellite system availability, efficiency and/or economic viability by terrestrially reusing at least some of the frequency bands that are allocated to satellite systems. In particular, it is known that it may be difficult for satellite systems to reliably serve densely populated areas, because the satellite signal may be blocked by high-rise structures and/or may not penetrate into buildings. As a result, the satellite spectrum may be underutilized or unutilized in such areas. The terrestrial reuse of at least some of a satellite band's frequencies can reduce or eliminate this potential problem.

Moreover, the capacity of the overall system can be increased significantly by the introduction of terrestrial reuse of a satellite band's frequencies, since terrestrial frequency reuse can be much denser than that of a satellite-only system. In fact, capacity can be enhanced where it may be mostly needed, i.e., densely populated urban/industrial/commercial areas. As a result, the overall system can become much more economically viable, as it may be able to serve a much larger subscriber base.

Aggregate power control may be used when satellite frequencies are reused terrestrially to reduce or prevent radiation by the terrestrial network and the UEs from interfering with the satellite communications. Several examples of aggregate power control have been described in other U.S. patents.

One example of aggregate power control is described in U.S. Pat. Nos. 7,706,826 and 7,113,778 entitled “Aggregate Radiated Power Control for Multi-band/Multi-mode Satellite Radiotelephone Communications Systems and Methods,” the disclosure of which is hereby incorporated herein by reference in its entirety as if set forth fully herein. As described therein, a satellite radiotelephone system includes a space-based component that is configured to communicate with multiple radiotelephones over multiple frequency bands and/or multiple air interfaces. An ancillary terrestrial network is configured to communicate terrestrially with the multiple radiotelephones over substantially the multiple frequency bands and/or substantially the multiple air interfaces. An aggregate radiated power controller is configured to limit an aggregate radiated power by the multiple radiotelephones to a maximum aggregate radiated power. See the common abstract of U.S. Pat. Nos. 7,706,826 and 7,113,778.

Another example of aggregate radiated power control is described in U.S. Pat. No. 7,623,859 entitled “Additional Aggregate Radiated Power Control for Multi-band/Multi-mode Satellite Radiotelephone Communications Systems and Methods,” the disclosure of which is hereby incorporated herein by reference in its entirety as if set forth fully herein. As described therein, an Ancillary Terrestrial Network (ATN) includes at least one Ancillary Terrestrial Component (ATC) that is configured to provide wireless communications using frequencies of a satellite frequency band. The ATN provides communications based on a GSM, cdma2000 and/or W-CDMA air interface, under a constrained capacity measure. The capacity measure of the ATN may also be constrained when the ATN provides communications based on an Orthogonal Frequency Division Multiplexed (OFDM) and/or Orthogonal Frequency Division Multiple Access (OFDMA) air interface. Analogous methods of controlling an ATN also may be provided. See the abstract of U.S. Pat. No. 7,623,859.

### SUMMARY OF THE INVENTION

Long Term Evolution (LTE) networks include resource blocks that may be allocated to various user equipments (UEs). In some embodiments, a maximum number of UEs in the LTE network that are permitted to transmit in a time period using a given resource block may be determined according to an upper limit on the overall transmission power in the LTE network for the given resource block. The given resource block may be allocated in the time period to up to the maximum number of UEs based on each UE's geographic location within the network. The maximum number of UEs that are permitted to transmit may be determined by selecting a transmit power level for each of the up to the maximum number of UEs such that a sum of the transmit power levels for the given resource block does not exceed a maximum aggregate transmit power. The UEs transmitting using the given resource block in the time period may be associated with multiple base stations. In some embodiments, each resource block is allocated to a maximum of one UE per cell in the time period. Each UE that is permitted to transmit may be associated with one or more resource blocks in the time period.

In some embodiments, during the time period, the given resource block may be allocated to up to the maximum number of UEs, each having the geographic location in a geographic region within the network. In some embodiments, the time period may be a first time period, and the geographic region may be a first geographic region. During a second time period, the given resource block may be allocated to up to the maximum number of UEs each having the geographic location in a second geographic region within the network. The second geographic region may be different from the first geographic region.

In some embodiments, determining the maximum number of user equipments may include determining the maximum aggregate transmit power for the given resource block based on a power mask that is independent of the given resource block. The transmit power level for each of the up to the maximum number of UEs may be determined by selecting transmit power levels of the UEs that follow a Gaussian distribution. A maximum number of UEs that are permitted to transmit in a time period using the given resource block may be selected to be a deterministic maximum number of UEs to be scheduled over the LTE network. Alternatively, a maximum number of UEs that are permitted to transmit in a time period using the given resource block may be a randomly distributed maximum number of UEs to be scheduled over the LTE network. The maximum number of UEs that are permitted to transmit in a time period using the given resource block may be determined by selecting an average value of a Poisson distributed maximum number of UEs to be scheduled over the LTE network.

In some embodiments, determining the maximum number of user equipments may include determining the maximum aggregate transmit power for the given resource block based on a power mask that is dependent on the given resource block. The transmit power level for each of the up to the maximum number of UEs may be determined by selecting transmit power levels of the UEs that follow a Gaussian distribution. A maximum number of UEs that are permitted to transmit in a time period using the given resource block may be selected to be a deterministic maximum number of UEs to be scheduled over the LTE network. Alternatively, a maximum number of UEs that are permitted to transmit in a time period using the given resource block may be a randomly distributed maximum number of UEs to be scheduled over the LTE network. The maximum number of UEs that are permitted to transmit in a time period using the given resource block may be determined by selecting an average value of a Poisson distributed maximum number of UEs to be scheduled over the LTE network.

In some embodiments, the resource blocks in the LTE network may each include twelve subcarriers in a frequency domain across at least one time slot. The time period may be a time slot of fixed duration.

In some embodiments, the maximum number of UEs that are permitted to transmit in the time period using the given resource block may be determined to be different maximum numbers of UEs that are permitted to transmit using different resource blocks during the time period. The given resource block in the time period may be allocated to up to the maximum number of UEs based on each UE's geographic location within the network by allocating the different resource blocks in the time period to a different maximum number of UEs.

In some embodiments, the given resource block used by a UE in a cell may be selected based on the channel quality indicator (CQI) of the UE. The total transmit power of the UEs allocated to the given resource block may be estimated. Additionally, based on the estimate of total transmit power of the UEs, feedback may be provided to base stations in the LTE network, to adjust the number of UEs allocated to the given resource block. In some embodiments, estimating the total transmit power of the UEs and providing feedback to the base stations may be performed by a controller. The controller may include a network power controller associated with all base stations in the LTE network. The controller may include a central power controller associated with base stations in a geographic region within the LTE network. One or more UEs may be configured to communicate with the controller. A UE may be configured to use the resource blocks that are allocated.

It will be understood that various embodiments have been described above in connection with resource block allocation methods. However, various other embodiments described herein can provide a controller that can be used in a LTE network to allow resource block allocation across a LTE network. Analogous resource block allocation computer program products may also be provided according to various embodiments described herein. The controller described herein may be used in combination with base stations. In some embodiments, a base station may be configured to communicate with the controller described herein. In some embodiments, the controller may be designed and integrated in a core network element that is reachable from all switching centers throughout the whole United States.

It is noted that aspects described herein with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present disclosure, and be protected by the accompanying claims.

### BRIEF DESCRIPTION OF THE DRAWINGS

FIG. 1 is a schematic diagram of wireless systems and methods according to embodiments of the invention.

FIG. 2 is a schematic diagram illustrating near and far effects on satellite interference, according to various embodiments described herein.

FIG. 3 is a flowchart illustrating resource block allocation in a LTE network, according to various embodiments described herein.

FIG. 4 is a flowchart illustrating determination of a maximum number of UEs permitted to transmit using a resource block, according to various embodiments described herein.

FIG. 5 is a flowchart illustrating allocating a resource block up to a maximum number of UEs based on the UE's geographic location, according to various embodiments described herein.

FIG. 6 illustrates an L-Band spectrum plan for ancillary terrestrial network deployment.

FIG. 7 is a table illustrating the emission requirement for each UL category.

FIG. 8 is a table illustrating resource block power spectral density (PSD) limitations of an L-Band link.

### DETAILED DESCRIPTION OF PREFERRED EMBODIMENTS

Various embodiments will be described more fully hereinafter with reference to the accompanying drawings. Other embodiments may take many different forms and should not be construed as limited to the embodiments set forth herein. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the various embodiments described herein. As used herein, the term “and/or” includes any and all combinations of one or more of the associated listed items.

The terminology used herein is for the purpose of describing particular embodiments only and is not intended to be limiting to other embodiments. As used herein, the singular forms “a,” “an” and “the” are intended to include the plural forms as well, unless the context clearly indicates otherwise. It will be further understood that the terms “comprises,” “comprising,” “includes” and/or “including,” “have” and/or “having” when used herein, specify the presence of stated features, integers, steps, operations, elements, and/or components, but do not preclude the presence or addition of one or more other features, integers, steps, operations, elements, components, and/or groups thereof. Elements described as being “to” perform functions, acts and/or operations may be configured to or other structured to do so.

Unless otherwise defined, all terms (including technical and scientific terms) used herein have the same meaning as commonly understood by one of ordinary skill in the art to which various embodiments described herein belong. It will be further understood that terms used herein should be interpreted as having a meaning that is consistent with their meaning in the context of this specification and the relevant art and will not be interpreted in an idealized or overly formal sense unless expressly so defined herein.

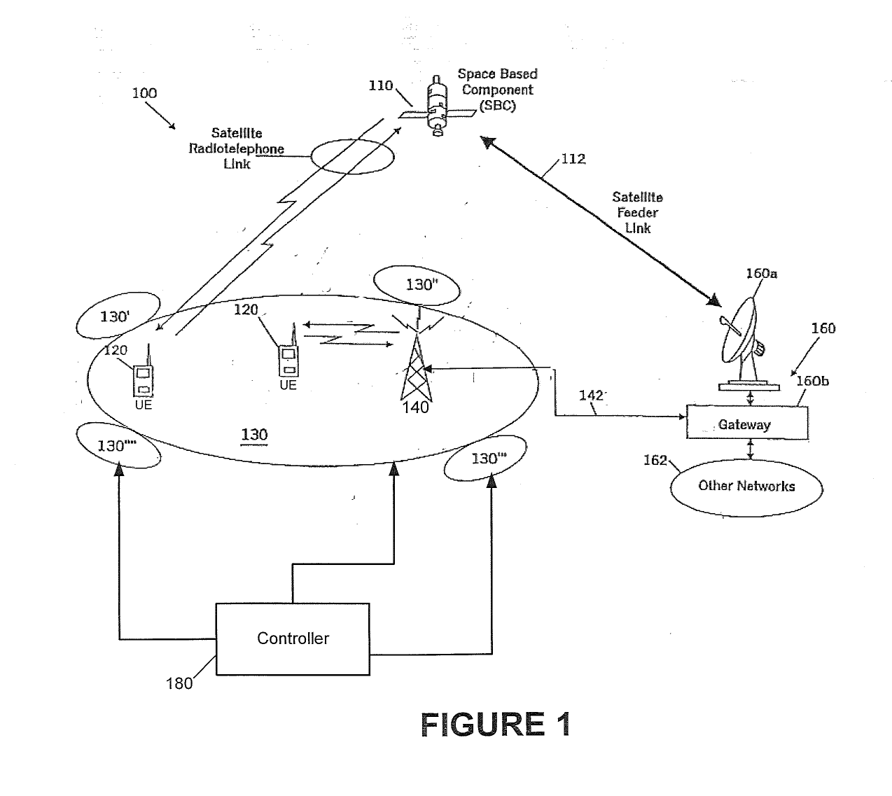

FIG. 1 is a schematic diagram of wireless communication systems and methods according to various embodiments described herein. As shown in FIG. 1, these wireless systems and methods 100 include at least one Space-Based Component (SBC) 110, such as a satellite. In some embodiments, the wireless system may be an LTE network. The space-based component or satellite 110 is configured to transmit wireless communications to a plurality of user equipments (UEs) 120 in a satellite footprint comprising one or more cells 130-130″″ over one or more satellite wireless links. As used herein, cell 130 will refer collectively to one or more cells 130-130″″. The space-based component 110 is configured to receive wireless communications from, for example, a first UE 120 in the cell 130 over a satellite wireless return link. An ancillary terrestrial network, comprising at least one ancillary terrestrial component and/or eNodeB and/or base station 140, which may include an antenna and an electronics system, is configured to receive terrestrial communications from, for example, a second UE 120 in the cell 130 over the satellite wireless uplink. Thus, as illustrated in FIG. 1, one UE 120 may be communicating with the space-based component 110 while another UE 120 may be communicating with the ancillary terrestrial component 140. As shown in FIG. 1, the space-based component 110 also undesirably receives the wireless communications from the second UE 120 in the cell 130 as interference.

Still referring to FIG. 1, embodiments of satellite wireless communications systems/methods 100 can include at least one gateway 160 that can include an antenna 160a and an electronics system 160b that can be connected to other networks 162 including terrestrial and/or other wireless networks. The gateway 160 also communicates with the space-based component 110 over a satellite feeder link 112. The gateway 160 also communicates with the ancillary terrestrial component or base station 140, generally over a terrestrial link 142.

Various embodiments of the elements of FIG. 1 as described above are described for example in U.S. Pat. Nos. 6,684,057; 6,785,543; 6,856,787; 6,859,652; 6,879,829; 6,892,068, 6,937,857, 6,999,720 and 7,006,789; 7,418,263; 7,447,501; 7,599,656; 7,603,081; and 8,249,585, the disclosures of all of which are hereby incorporated herein by reference in their entirety as if set forth fully herein.

Various embodiments described herein may determine a maximum number of UEs 120 in the LTE network that are permitted to transmit in a given time period using a given resource block according to an upper limit on the overall transmission power in the LTE network for the given resource block. A controller 180 may be in communication with base stations 140 in the LTE network. The controller 180 may allocate the resource blocks across a LTE network. The controller 180 may allocate a given resource block in the time period to up to a maximum number of UEs based on each UE's geographic location within the LTE network. Controller 180 may be part of the infrastructure of the wireless network (e.g. base station, eNodeB, Radio Access Network Node, and/or Mobile Switching Center), in the gateway, and/or in a stand-alone unit.

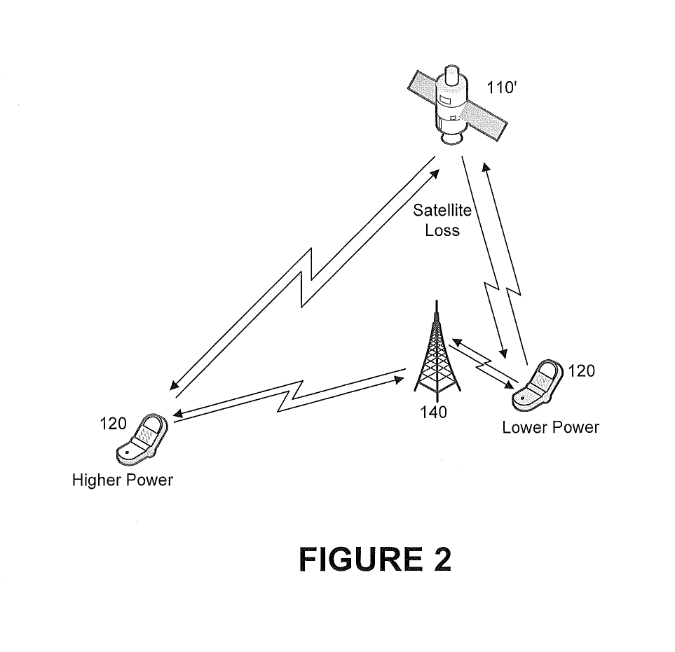

FIG. 2 is a schematic diagram illustrating near and far effects on satellite interference. A UE 120 closer to the base station 140 may transmit with lower power while a UE 120 farther from the base station 140 may transmit with higher power. If the transmit power from all UEs 120 is the same, the interference to the victim satellite 110′ may be identical. The victim satellite may be a satellite 110 of the operator's own wireless satellite system or may be a satellite 110′ of another wireless satellite system.

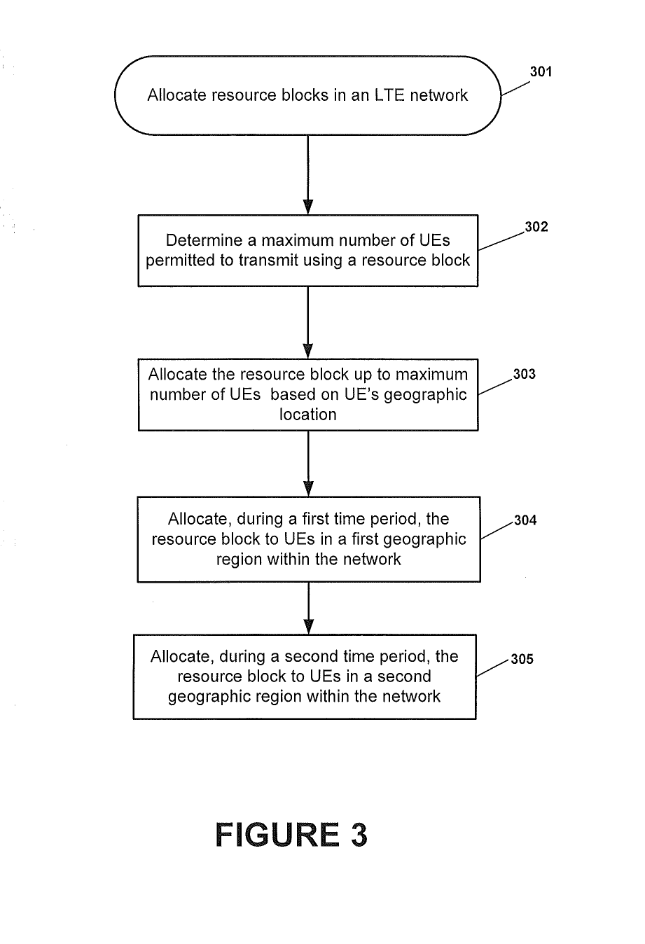

FIG. 3 is a flowchart illustrating operations 301 that may be performed by a controller in an LTE network to allocate resource blocks. These operations, for example may be performed by controller 180 of FIG. 1. As illustrated in block 302, a maximum number of UEs permitted to transmit in a time period using a given resource block may be determined. This maximum number of UEs permitted to transmit using a given resource block may be according to an upper limit on the overall transmission power in the LTE network for the given resource block.

As illustrated in block 303 of FIG. 3, the allocation of the given resource block in the time period (such as in an LTE time slot) to up to the maximum number of UEs may be based on each UE's 120 geographic location within the network. The maximum number of UEs that are permitted to transmit may be determined by selecting a transmit power level for each of the up to the maximum number of UEs such that a sum of the transmit power levels for the given resource block does not exceed a maximum aggregate transmit power. In some embodiments, the UEs 120 transmitting using the given resource block in the time period may be associated with multiple base stations 140. In a time period, each resource block may be allocated to a maximum of one UE 120 per cell. Each UE 120 that is permitted to transmit may be associated with one or more resource blocks in the time period.

During a time period, the given resource block may be allocated to UEs 120 whose geographic location is in one or more geographic regions within the network, as illustrated in block 304 of FIG. 3. As further illustrated in block 305 of FIG. 3, a given resource block may be allocated during a first time period to UEs in a first geographic region and during a second time period to UEs in a second geographic region. In some embodiments, the second geographic region may be different from the first geographic region.

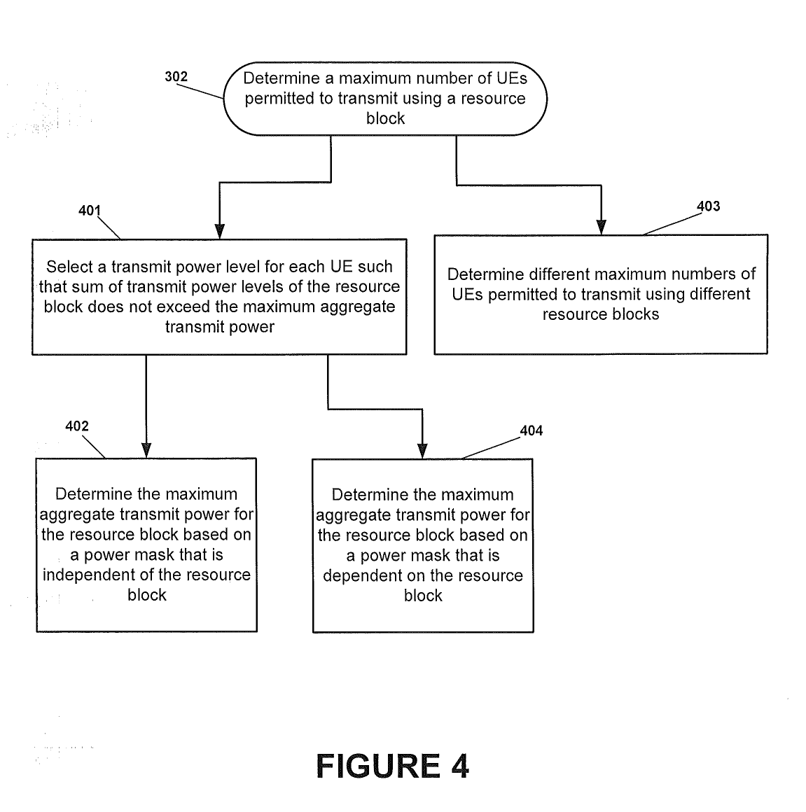

FIG. 4 is a flowchart illustrating determination of a maximum number of UEs permitted to transmit using a resource block according to various embodiments of the present disclosure, which may correspond to block 302 of FIGS. 3 and 4. According to block 401 of FIG. 4, a transmit power level for each of the up to the maximum number of UEs may be selected such that a sum of the transmit power levels for the given resource block does not exceed a maximum aggregate transmit power.

In some embodiments, corresponding to block 402 of FIG. 4, the maximum number of UEs may be determined by the maximum aggregate transmit power for the given resource block based on a power mask that is independent of the given resource block. The transmit power levels of the UEs 120 may be selected to follow a Gaussian distribution. The maximum number of UEs that are permitted to transmit in a time period using the given resource block may be selected to be a deterministic number of UEs 120 to be scheduled over the LTE network. The maximum number of UEs that are permitted to transmit in a time period using the given resource block may be a randomly distributed number of UEs 120 to be scheduled over the LTE network. The maximum number of UEs that are permitted to transmit in a time period using the given resource block may be selected such that an average value of a Poisson distributed maximum number of UEs are scheduled over the LTE network.

In some embodiments, corresponding to block 404 of FIG. 4, the maximum number of user equipments may be determined by the maximum aggregate transmit power for the given resource block based on a power mask that is dependent on the given resource block. The transmit power levels of the UEs 120 may be selected to follow a Gaussian distribution. The maximum number of UEs that are permitted to transmit in a time period using the given resource block may be selected to be a deterministic number of UEs 120 to be scheduled over the LTE network. The maximum number of UEs that are permitted to transmit in a time period using the given resource block may be a randomly distributed number of UEs 120 to be scheduled over the LTE network. The maximum number of UEs that are permitted to transmit in a time period using the given resource block may be selected such that an average value of a Poisson distributed maximum number of UEs are scheduled over the LTE network.

In some embodiments, the resource blocks in the LTE network may each include one or more subcarriers in a frequency domain across at least one time slot. In some example embodiments, the resource blocks in the LTE network may each include twelve subcarriers in a frequency domain across at least one time slot. The time period may be a time slot of fixed duration. The time period may also vary in duration from one time slot to the next time slot.

FIG. 4 illustrates other embodiments of determining a maximum number of UEs permitted to transmit in the time period using the given resource block, corresponding to block 403. As illustrated in block 403, for different resource blocks, different maximum numbers of UEs that are permitted to transmit may be determined during a time period.

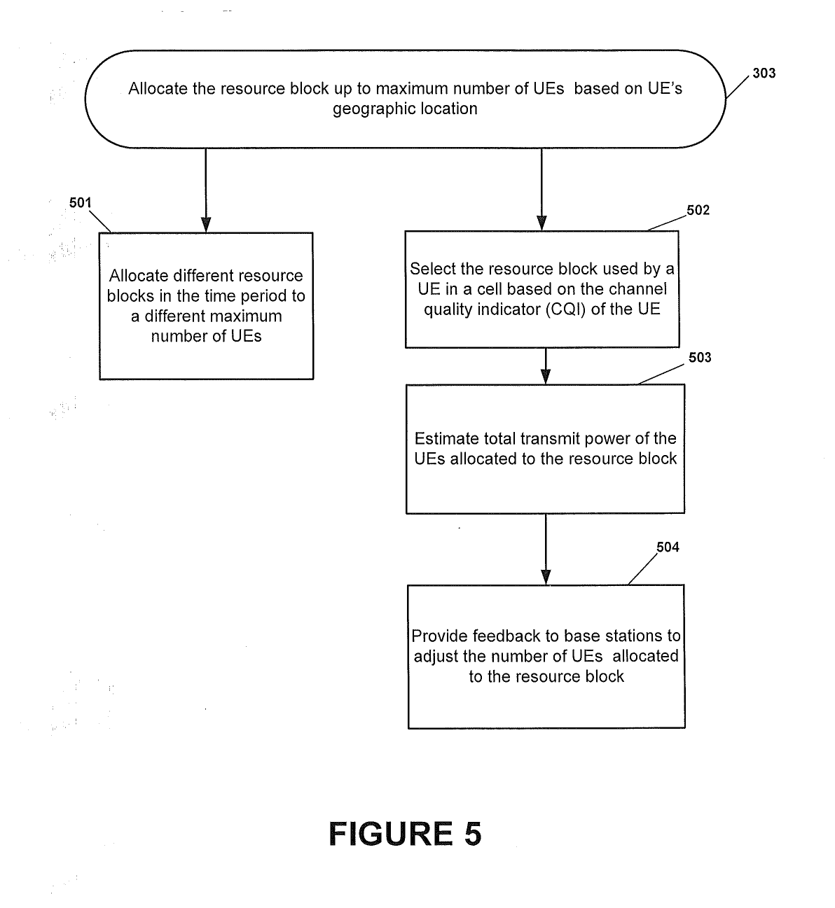

FIG. 5 is a flowchart illustrating allocating a resource block up to a maximum number of UEs based on the UE's 120 geographic location according to various embodiments of the present disclosure, which may correspond to block 303 of FIGS. 3 and 5. As illustrated in block 501, allocating the given resource block in the time period to up to the maximum number of UEs based on each UE's 120 geographic location within the network may include allocating a different maximum number of UEs to different resource blocks in a time period.

As illustrated in block 502 of FIG. 5, the resource block used by a UE 120 in a cell may be selected based on the channel quality indicator (CQI) of the UE 120. The UEs 120 may be scheduled on the resource blocks with a power mask with lower sensitivities to the interference level. This approach is channel quality indicator (CQI) dependent resource block scheduling, which will be discussed in greater detail later in this disclosure. Allocating a given resource block may be based on estimating total transmit power of the UEs 120 allocated to the given resource block, as illustrated by block 503 of FIG. 5.

Furthermore, feedback may be provided to base stations 140 in the LTE network, based on the estimate of total transmit power of the UEs 120 allocated to a give resource block in order to adjust the number of UEs allocated to the given resource block, as illustrated in block 504 of FIG. 5. Estimating the total transmit power of the UEs 120 may be performed by a controller 180, as in FIG. 1. The controller 180 may be a network power controller associated with one or more base stations 140 in the LTE network. The controller 180 may be a central power controller associated with one or more base stations 140 in one or more geographic regions within the LTE network.

Additional discussion of various embodiments will now be provided. These embodiments will be described within the context of specific plans of a wireless operator, referred to herein as “LightSquared”, and will be described using specific frequency carriers and an LTE network. It will be understood, however, that these embodiments are merely illustrative, and various embodiments described herein may be used with different operators and different frequency carriers.

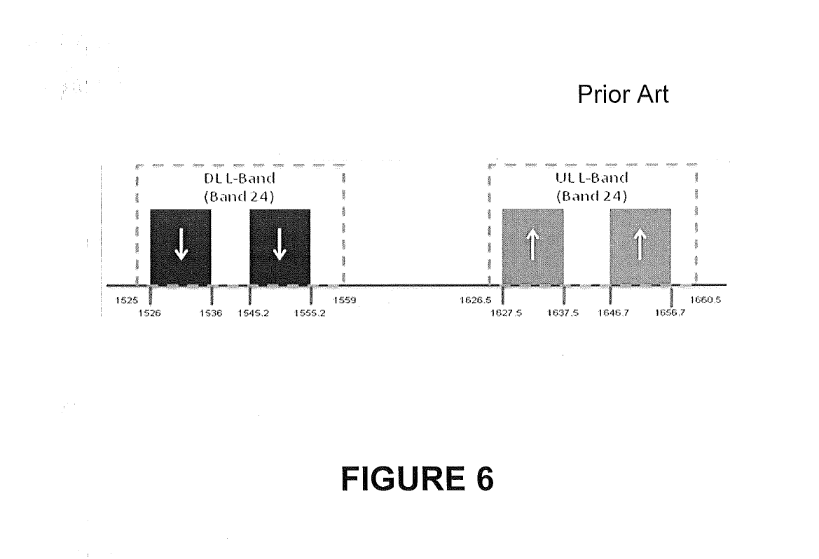

LightSquared is authorized to launch a nationwide 4G LTE terrestrial network in L-Band frequencies, as depicted in FIG. 6. The LTE channels that LightSquared is authorized to deploy reuse spectrum coordinated with other Mobile SatelliteSystems (MSS) operations from, for example Inmarsat, Russia and Mexico. The aggregate uplink (UL) LTE UE power transmission towards each of these satellite systems is limited by separate bi-lateral coordination agreements with them. The limit on total UL transmit power is calculated according to the proposed received power level by those satellite systems, and converted using standard values for path loss and fading from terrestrial terminals to satellite receivers. The proposed limits are different in different parts of the uplink spectrum, requiring a careful categorization and scheduling mechanism for UL LTE deployment.

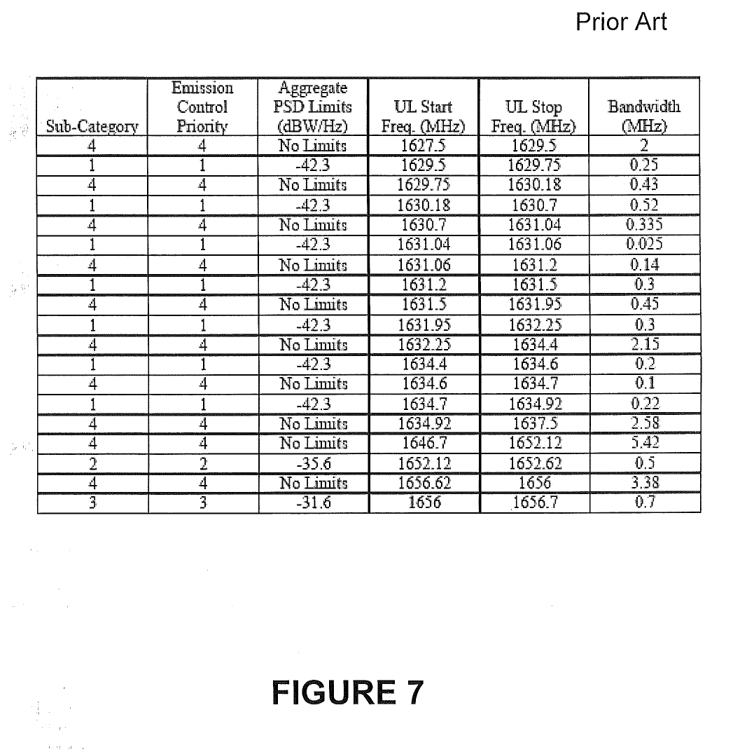

The frequencies requiring emission control may be divided into four categories based on how much aggregate emission control is tolerated. FIG. 7 depicts the tolerated power level at each sub-band categories. Priority 1 requires the highest level of emission control (lowest aggregate UL power, or the most restrictive UL traffic and power assignment by the scheduler), and priority 4 requires the least amount of emission control (highest aggregate UL power, or the least restrictive UL traffic and power assignment by the scheduler). The potentially non-contiguous spectrum covered by each of these priorities may be a sub-band. This sub-band classification and prioritizations are based on current requirements and can change over time. Therefore, the definition of sub-bands (in terms of center frequency and spectral width) and their assigned emission control priority may be operator configurable.

In LTE, every 12 OFDM subcarriers (15 KHz) in the frequency domain across one time slot (0.5 ms) in the time domain constitute a Resource Block (RB) of 180 KHz in frequency and 0.5 ms in time. In a 10 MHz LTE deployment, only the center 9 MHz may be used for transmission and the rest of the frequency (1 MHz) may be used for guard bands of 0.5 MHz on each side of the channel. As a result, 9 MHz/180 KHz=50 resource blocks are embedded in a 10 MHz bandwidth LTE channel, both in the downlink and the uplink. These numbers may comprise 25 resource blocks, 75 resource blocks, and 100 resource blocks, for 5 MHz, 15 MHz, and 20 MHz channel bandwidths respectively.

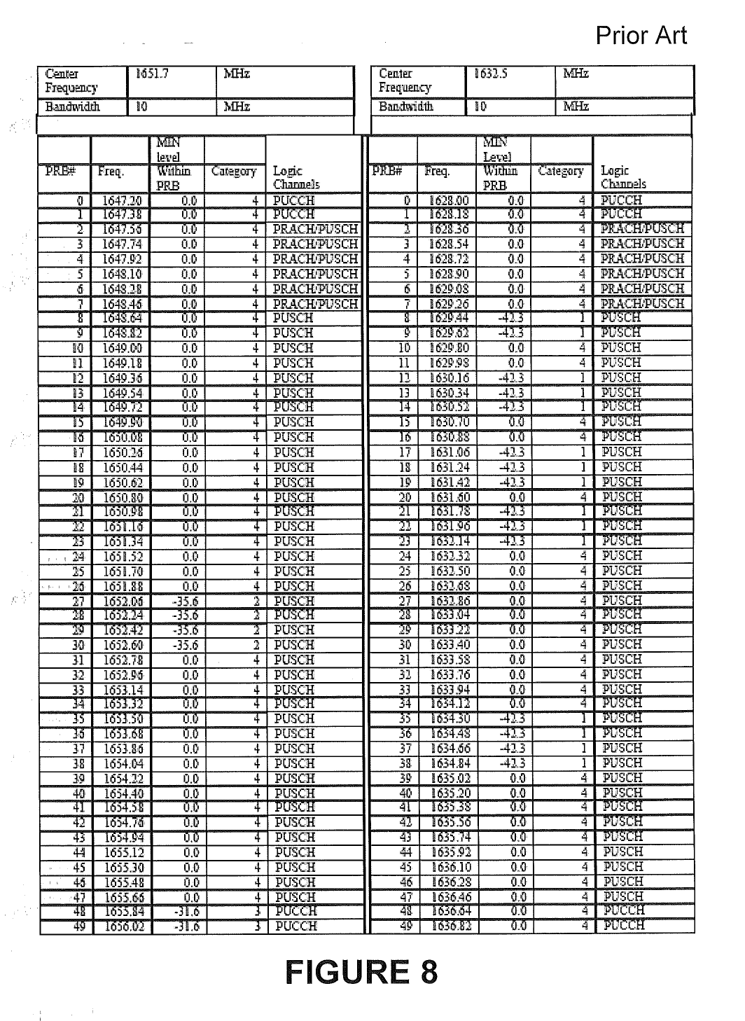

FIG. 8 illustrates an example mapping of the sub-bands listed in FIG. 7 into LTE resource block numbers for a 10 MHz channel. The Category column of FIG. 8 relates the four subcategories of sub-bands in FIG. 7 with the fifty resource blocks of a 10 MHz channel. For example, category 1 resource blocks of FIG. 8 map to sub-category 1 of FIG. 7 with aggregate Power Spectral Density (P SD) limits of −42.3 dBW/Hz while category 2 resource blocks of FIG. 8 map to sub-category 2 of FIG. 7 with aggregate PSD limits of −35.6 dBW/Hz.

Similar mapping could be performed for the case of 5 MHz channel, either the upper half or lower half of UL 10 MHz channels in FIG. 6. To calculate the aggregate PSD limit per resource block, 52.55 dB (=10 log(180 KHz)) may be added to each of the limits defined in the second column of FIG. 7. The calculations yield the values 10.25 dBm/resource block, 16.95 dBm/resource block, and 21.95 dBm/resource block, and no limit for categories 4 to 1 respectively.

Several solutions may be applied to this complicated problem. Some solutions attempt to address this issue by placing some restrictions on the uplink scheduler within a particular cell. However, the UEs may be distributed nationwide in a number of geographical areas in different locations. Thus, the control mechanisms may need to be distributed nationwide, which makes the task of scheduling and power control more challenging.

Various embodiments described herein addresses the power control problem in the context of a nationwide or large area deployment. As previously discussed, a maximum number of UEs in the LTE network that are permitted to transmit in a time period using a given resource block may be determined according to an upper limit on the overall transmission power in the LTE network for the given resource block. The given resource block may be allocated in the time period to up to the maximum number of UEs based on each UE's geographic location within the network.

Embodiments relating to an open-loop resource block allocation, as illustrated for example in blocks 302-305 of FIG. 3 and blocks 401-404 of FIG. 4, such that the required power mask may be independent of the resource blocks will be described. N may be a total number of UEs 120 to be scheduled over the uplink in the whole nationwide network. Pₐ may be the power of UE #n, nε{1, . . . , N} where E[Pₙ]=μ_{P} and Var[Pₙ]=σ_{P}². The power of the UEs 120 (Pₙ, nε{1, . . . , N}) may be controlled by various embodiments described herein. The total transmit power by the UEs depicted by “P_{T}” is equal to

$${P}_{T} = {\sum }_{n = 1}^{N} {P}_{n} \qquad ( 1 )$$

Since the distances from the UEs 120 to the satellite 110 may be almost equal, it may be desirable to control the total transmitted power by the UEs 120, as illustrated in FIG. 4.

Due to potential underutilization of the network resources, it may not be desirable in some embodiments to use deterministic power control. A deterministic power control approach as illustrated in block 401 of FIG. 4 keeps the total power (P_{T}) below the given maximum power of P_{Max} all the time. However, due to considerable underutilization of the network resources at some points in time according to some embodiments, it may not be desired in some embodiments to use deterministic power control. In some embodiments, probabilistic power control may be applied, where the total power (P_{T}) may be below the maximum power (P_{Max}) with a high probability:

P[P_{T}≧P_{Max}]≦ε (2)

where ε is a given small number. The total number of the UEs 120 that are scheduled on a link may be limited in any cell. The total number of the UEs 120 that are scheduled on a link across the LTE network may be limited.

The power of the UE #n may be a random variable, which may depend on the distance of UE #n to the base station 140 that a UE 120 may be registered to. An approximate assumption may be made that the random variables Pₙ are independent and identically distributed (i.i.d), as in block 402 or FIG. 4. In some embodiments, such as illustrated in block 404 of FIG. 4, this assumption may not be a very accurate assumption since the powers of the UEs 120 located within the same cell 130 depend on each other through the power control mechanism. However, for multiple cells in the network the assumption may be made that the power control mechanisms of multiple cells are independent. Hence, the assumption of independence, and therefore, i.i.d. random variables is possible in some embodiments.

In some embodiments, N may be a deterministic variable. Using the Central Limit Theorem (CLT), the total transmitted power by the UEs 120 (P_{T}) may follow a Gaussian distribution as follows:

P_{T}˜ [symbol] (Nμ_{P},Nσ_{P}²) (3)

Thus, equation (2) may be rewritten as follows:

$$P [ \frac{{P}_{T} - N {μ}_{P}}{{σ}_{p} \sqrt{N}} \geq \frac{{P}_{Max} - N {μ}_{P}}{{σ}_{P} \sqrt{N}} ] \leq ε \qquad ( 4 )$$

Due to (3), equation (4) may be rewritten as:

$$Q ( \frac{{P}_{Max} - N {μ}_{P}}{{σ}_{P} \sqrt{N}} ) = ε \qquad ( 5 )$$

where the Q Function represents the probability of a zero mean unity variance Gaussian random variable being greater than a certain value. Equation (5) may be solved for N*, the maximum number of UEs that can be scheduled on the link across the LTE network. Equation (5) may be solved for N. Equation (5) can be re-written as follows:

$$Q ( \frac{{P}_{Max} - {N }^{*} {μ}_{P}}{{σ}_{P} \sqrt{{N}^{*}}} ) = ε \qquad ( 6 )$$

under the assumption:

φ=Q⁻¹(ε) (7)

Given ε, φ may be obtained from equation (7). Therefore, equation (6) may be re-written as:

$$\frac{{P}_{Max} - {N}^{*} {μ}_{P}}{{σ}_{P} \sqrt{{N}^{*}}} = ϕ \qquad ( 8 )$$

After some mathematical manipulations, equation (8) may be rewritten as:

μ_{P}(\sqrt{N*})²+φσ_{P}(\sqrt{N*})−P_{Max}=0 (9)

Solving for N* equation (9) may be rewritten as:

$${N}^{*} = \frac{2 {σ}_{P}^{2} {ϕ}^{2} + 4 {μ}_{P}^{2} {P}_{Max} - 2 {σ}_{P} ϕ \sqrt{{σ}_{P}^{2} {ϕ}^{2} + 4 {μ}_{P} {P}_{Max}}}{4 {μ}_{P}^{2}} \qquad ( 10 )$$

The parameters on the right hand side of (10) may be available to a LTE network operation through Operations & Management (OAM) operations, and by assuming φ=Q⁻¹(ε). Thus, the above analysis obtains the maximum number of UEs 120 (N*), that can be scheduled simultaneously in the link over the LTE network.

Given N*, a mechanism may be needed to provide a reserved capacity for each market or geographic area as illustrated, for example, in blocks 303-305 of FIG. 3, and from the quota of each geographic area, the capacity for each cell 130, defined as the maximum number of simultaneous UEs 120 that can be scheduled on the link in a cell 130 in a given geographic area. This capacity proportionally depends on the geographic area location, cell location in the geographic area, the time of the day, and/or other events. For example, the number of active UEs in New York City is expected to be higher than a smaller geographic area, e.g., Baltimore; thus the quota for the New York geographic area in some situations may be higher than the Baltimore geographic area. On the other hand, a cell in Manhattan may be expected to deal with a higher number of active UEs 120 than a cell in the suburb of New York City.

Another factor for determining the number of UEs may be dependent on the time zone as illustrated in blocks 304 and 305 of FIG. 3. For example, at 8:00 am EST, few active UEs 120 are expected in geographic areas on the west coast, even big cities such as San Francisco or Los Angeles. However, local events may change the number of active UEs in each geographic area and/or cell. The capacity of different geographic areas and different cells in the network may be estimated using the traffic forecast and may be stored for each base station 140. The number of UEs 120 of each geographic area and cell may be adjusted dynamically based on measured traffic in each geographic area and cell.

In some embodiments, the maximum number of UEs 120 to be scheduled (N) may be randomly distributed. In this case, assumptions such that E[N]=μ_{N} and Var[N]=σ_{N}² may be made. Under such assumptions, the total transmitted power of the UEs 120 (P_{T}) is a random sum of random variables with a stopping time of N. Using the Anscombe Theorem, P_{T} may be approximated to be:

P_{T}˜ [symbol] (μ_{N}μ_{P},μ_{N}σ_{P}²+σ_{N}²μ_{P}²) (11)

In this case, the Q function could be re-written as follows:

$$Q ( \frac{{P}_{Max - {μ}_{N} {μ}_{P}}}{\sqrt{{μ}_{N} {σ}_{P}^{2} + {σ}_{N}^{2} {μ}_{P}^{2}}} ) = ε \qquad ( 12 )$$

This case requires controlling the mean (μ_{N}) and the variance (σ_{N}²) of N. However, this approach may make more efficient use of network resources.

In order to solve the above problem, a reasonable assumption that N approximately follows a Poisson distribution with parameter ρ_{N} may be made. The mean and the variance of the Poisson distribution are equal such that μ_{N}=ρ_{N} and σ_{N}²=ρ_{N}. Thus, equation (12) can be rewritten as follows:

$$Q ( \frac{{P}_{Max} - {ρ}_{N} {μ}_{P}}{\sqrt{{σ}_{P}^{2} + {μ}_{P}^{2}} \sqrt{{ρ}_{N}}} ) = ε \qquad ( 13 )$$

Equation (13) is similar to equation (5) with two differences: N is replaced by ρ_{N}, and σ_{P}² is replaced by (σ_{P}²+μ_{P}²). Using same approach as previous embodiments, the assumption may be made that φ=Q⁻¹(ε), to obtain:

$${ρ}_{N} = \frac{\begin{matrix}2 ( {σ}_{P}^{2} + {μ}_{P}^{2} ) {ϕ}^{2} + 4 {μ}_{P}^{2} {P}_{max} - 2 \sqrt{{σ}_{P}^{2} + {μ}_{P}^{2}} ϕ \\ \sqrt{( {σ}_{P}^{2} + {μ}_{P}^{2} ) {ϕ}^{2} + 4 {μ}_{ρ} {P}_{Max}}\end{matrix}}{4 {μ}_{P}^{2}} \qquad ( 14 )$$

Several further assumptions may include that equation (12) may be solved for ρ_{N}, the total number of cells in the network may be represented by I, Nᵢ represents the number of UEs 120 in cell i (iε{1, . . . , I}), and the E[Nᵢ]=Var[Nᵢ]=ρ_{Ni}.

With these assumptions equations (15) and (16) simplify to:

N=Σᵢ₌₁^{I}Nᵢ (15)

ρ_{N}=Σᵢ₌₁^{I}ρ_{N}_{ᵢ} (16)

The control mechanism may use the same capacity control approach mentioned in previous embodiments to proportionally limit the capacity of each geographical area and each cell 130 within a geographical area. In this case, a base station 140 may control the average number of the UEs 120.

In some embodiments, a conservative value for the maximum number of UEs may be estimated in the LTE network to be N*. In some embodiments the average number of the UEs may be estimated to be ρ_{N}. These numbers may represent the total number of UEs aggregated over one or more the geographical areas.

In some example embodiments illustrated, for example, in block 303 of FIG. 3, the capacity of each geographical area is identified by estimating the total number of UEs 120 that can be scheduled within the geographical area proportional to the traffic of the geographical area. The capacity of the geographical area may be expected to be a function of time, and potentially other events.

Knowing the capacity of a geographical area, a cell capacity may be estimated by examining the traffic handled by the cell, the cell location, time, and other events. The cell capacity will be used by the base station scheduler for scheduling on the link. In some embodiments, the base station 140 of cell 130 #i is provided with the maximum number of the UEs (N_{Ni}) that can be scheduled at a given time, as illustrated, for example, in block 501 of FIG. 5. The value of N_{Ni} can be maintained in a lookup table or can be updated and provided to the base station 140 by a controller 180.

In some embodiments, the base station 140 of cell #i is provided with the average number of the UEs (ρ_{Ni}) that can be scheduled. In other words, in each scheduling time, the base station scheduler may have a token to schedule ρ_{Ni} UEs on the uplink, which may be considered to be the average of a Poisson random variable. At time t, the total token of the base station scheduler is represented by a credit represented by CR(t) where CR(0)=0. At time t+1, the credit is updated as follows: CR(t+1)=CR(t)+ρ_{Ni}−UEᵢ(t) where UEᵢ(t) is the number of the UEs that are scheduled for cell #i by the base station scheduler. The value of the UEᵢ(t) may depend on the QoS of the bearers as well as the amount of token collected by the cell #i. For multi-service embodiments the token based scheduler may be more complex.

Some embodiments relating to an open-loop resource block allocation such that the required power mask may be dependent on the resource blocks will be described, as illustrated in block 404 of FIG. 4. The required power mask may be a function of the resource block number. There may be K resource blocks available to be scheduled, including data and control resource blocks. Nₖ is the total number of UEs 120 to be scheduled on resource block #k across the LTE network. P_{n,k} may be the power of UE #n, which may assumed to be calculated from the power headroom reported by the UE 120 to the base station 140 where E[P_{n,k}]=μ_{P,k}, Var[P_{n,k}]=σ²_{P,k}, and the power of the UEs (P_{n,k}, nε{1, . . . , Nₖ} is controlled by a power control algorithm across the LTE network.

According to some embodiments, the total transmit power by the UEs scheduled on resource block #k may be depicted as P_{T,k}, and is equal to:

P_{T,k}=Σₙ₌₁^{N}^{ₖ}P_{n,k} (17)

Since the power mask may be dependent on the resource blocks, there may be a maximum allowed transmitted power for all UEs 120 over each resource block. P_{Max,k} may represent the maximum allowed total transmit power on resource block #k, according to FIG. 8. An objective may be to keep the total transmitted power over resource block #k (P_{T,k}) below a maximum power of resource block #k (P_{Max,k}) with a high probability, as per the following equation:

P[P_{T,k}≧P_{Max,k}]≦ε (18)

where ε is a given small number.

Using an approach similar to the frequency independent power mask, the maximum number of UEs that can be scheduled over any specific resource block, Nₖ*, across the LTE network may be obtained. Also, using the same approach, the capacity of resource block #k for each geographic area and also the capacity of each cell #i, N_{k,i}* may be calculated. Using the same token based approach discussed with respect to previous embodiments, the scheduler of the base station 140 of cell 130 #1 may make scheduling decisions over resource block #k dependent on N_{k,i}*.

In some embodiments, the power control mechanism may adjust the power of the UEs 120 based on the channel quality indicators (CQIs) of the UEs 120, as illustrated, for example, in block 502 of FIG. 5. The CQIs of the UEs 120 may depend on the distance between each UE 120 and the base station 140, shadowing, and fast fading. In other words, UEs 120 closer to the base station 140 may transmit with lower power, while the UEs 120 further from the base station 140 may transmit with higher power. However, the interferences from all UEs to the victim satellite may be almost identical in some embodiments. In these embodiments, the UEs 120 at the cell edge may have higher contribution to the interference to the victim satellites. These UEs 120 may be scheduled on the resource blocks on the power mask with lower sensitivities to the interference level. This approach is CQI dependent resource block scheduling. FIG. 3 illustrates that the UEs 120 further from the base station 140 may transmit with higher power compared to the UEs 120 closer to the base station 140, but may encounter equivalent interference to a victim satellite 110.

In some embodiments of CQI dependent resource block scheduling, the UEs 120 may be scheduled on different resource blocks depending on their CQI values. This mapping of the CQIs to UEs may be deterministic or probabilistic. In deterministic embodiments, UEs 120 may be partitioned based on their CQI values and each partition may be mapped to a specific resource block. Each UE may not have to fall in one partition and can be in multiple partitions to improve the scheduling efficiency. In the probabilistic case, the UEs 120 may be mapped to different partitions using a probabilistic distribution depending on their CQIs. This probabilistic approach may improve the maximum number of the UEs that can be scheduled on the uplink on any resource block #k.

In the previously discussed open loop mechanism, each cell may control the number of UEs without knowing the amount of interference at the victim satellite receiver. The system performance may be improved by estimating the total transmit power of the UEs 120 across the LTE network and using a feedback mechanism sent from a controller 180 to one or more base stations 140 in one or more geographic areas in order to adjust the number of UEs. Based on this feedback mechanism, the total transmit power at each cell 130, and on each resource block may be adjusted, as illustrated, for example, in block 504 of FIG. 5.

For purposes of illustration and explanation only, various embodiments of the present disclosure were described herein in the context of user equipment that are configured to carry out wireless communications (e.g., cellular voice and/or data communications). It will be understood, however, that the present invention is not limited to such embodiments and may be embodied generally in any wireless communication terminal that is configured to transmit and receive according to one or more radio access technologies.

As used herein, the term UE includes cellular and/or satellite user equipment such as radiotelephone(s) with or without a display (text/graphical); Personal Communications System (PCS) terminal(s) that may combine a radiotelephone with data processing, facsimile and/or data communications capabilities; Personal Digital Assistant(s) (PDA) or smart phone(s) that can include a radio frequency transceiver and a pager, Internet/Intranet access, Web browser, organizer, calendar and/or a global positioning system (GPS) receiver; and/or conventional laptop (notebook) and/or palmtop (netbook) computer(s) or other appliance(s), which include a radio frequency transceiver. As used herein, the term UE also includes any other radiating user device that may have time-varying or fixed geographic coordinates and/or may be portable, transportable, installed in a vehicle (aeronautical, maritime, or land-based) and/or situated and/or configured to operate locally and/or in a distributed fashion over one or more terrestrial and/or extra-terrestrial location(s) such as radiotelephones and radioterminals. Finally, the term “node” includes any fixed, portable and/or transportable device that is configured to communicate with one or more user equipment and a core network, and includes, for example, terrestrial cellular base stations (including microcell, picocell, wireless access point and/or ad hoc communications access points) and satellites, that may be located terrestrially and/or that have a trajectory above the earth at any altitude.

As used herein, the terms “comprise,” “comprising,” “comprises,” “include,” “including,” “includes,” “have,” “has,” “having,” or variants thereof are open-ended, and include one or more stated features, integers, elements, steps, components or functions but does not preclude the presence or addition of one or more other features, integers, elements, steps, components, functions or groups thereof. Furthermore, if used herein, the common abbreviation “e.g.,” which derives from the Latin phrase exempli gratia, may be used to introduce or specify a general example or examples of a previously mentioned item, and is not intended to be limiting of such item. If used herein, the common abbreviation “i.e.,” which derives from the Latin phrase id est, may be used to specify a particular item from a more general recitation.

Exemplary embodiments were described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by processor circuitry. These computer program instructions may be provided to processor circuitry of a general purpose computer circuit, special purpose computer circuit such as a digital processor, and/or other programmable data processor circuit to produce a machine, such that the instructions, which execute via the processor circuitry of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). These computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-Ray).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, embodiments of the present invention may be embodied in hardware and/or in software (including firmware, resident software, micro-code, etc.) that runs on a processor such as a digital signal processor, which may collectively be referred to as “processor circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments were disclosed herein, in connection with the following description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method for allocating resource blocks in a Long Term Evolution (LTE) network, the method comprising:
determining a maximum number of user equipments (UEs) in the LTE network that are permitted to transmit in a time period using a given resource block, according to an upper limit on the overall transmission power in the LTE network for the given resource block; and
allocating the given resource block in the time period to up to the maximum number of UEs based on each UE's geographic location within the network.

2. The method of claim 1, wherein determining the maximum number of UEs that are permitted to transmit comprises:
selecting a transmit power level for each of the up to the maximum number of UEs such that a sum of the transmit power levels for the given resource block does not exceed a maximum aggregate transmit power.

3. The method of claim 2, wherein the UEs transmitting using the given resource block in the time period are associated with multiple base stations.

4. The method of claim 1, wherein in the time period, each resource block is allocated to a maximum of one UE per cell.

5. The method of claim 1, wherein each UE that is permitted to transmit is associated with one or more resource blocks in the time period.

6. The method of claim 1, further comprising:
allocating, during the time period, the given resource block to up to the maximum number of UEs each having the geographic location in a geographic region within the network.

7. The method of claim 6, wherein the time period is a first time period, and wherein the geographic region is a first geographic region, the method further comprising:
allocating, during a second time period, the given resource block to up to the maximum number of UEs each having the geographic location in a second geographic region within the network,
wherein the second geographic region is different from the first geographic region.

8. The method of claim 2, wherein determining maximum number of UEs further comprises determining the maximum aggregate transmit power for the given resource block based on a power mask that is independent of the given resource block.

9. The method of claim 8, wherein selecting a transmit power level for each of the up to the maximum number of UEs comprises selecting transmit power levels of the UEs that follow a Gaussian distribution.

10. The method of claim 9, wherein determining a maximum number of UEs that are permitted to transmit in a time period using the given resource block comprises selecting a deterministic maximum number of UEs to be scheduled over the LTE network.

11. The method of claim 9, wherein determining a maximum number of UEs that are permitted to transmit in a time period using the given resource block comprises selecting a randomly distributed maximum number of UEs to be scheduled over the LTE network.

12. The method of claim 11, wherein determining a maximum number of UEs that are permitted to transmit in a time period using the given resource block comprises selecting an average value of a Poisson distributed maximum number of UEs to be scheduled over the LTE network.

13. The method of claim 2, wherein determining the maximum number of UEs for the given resource block further comprises determining the maximum aggregate transmit power for the given resource block based on a power mask that is dependent on the given resource block.

14. The method of claim 13, wherein selecting a transmit power level for each of the up to the maximum number of UEs comprises selecting transmit power levels of the UEs that follow a Gaussian distribution.

15. The method of claim 14, wherein determining a maximum number of UEs that are permitted to transmit in a time period using the given resource block comprises selecting a deterministic maximum number of UEs to be scheduled over the LTE network.

16. The method of claim 14, wherein determining a maximum number of UEs that are permitted to transmit in a time period using the given resource block comprises selecting a randomly distributed maximum number of UEs to be scheduled over the LTE network.

17. The method of claim 16, wherein determining a maximum number of UEs that are permitted to transmit in a time period using the given resource block comprises selecting an average value of a Poisson distributed maximum number of UEs to be scheduled over the LTE network.

18. The method of claim 1,
wherein the resource blocks in the LTE network each includes twelve subcarriers in a frequency domain across at least one time slot, and
wherein the time period is a time slot of fixed duration.

19. The method of claim 1,
wherein determining the maximum number of UEs that are permitted to transmit in the time period using the given resource block comprises determining different maximum numbers of UEs that are permitted to transmit using different resource blocks during the time period, and
wherein allocating the given resource block in the time period to up to the maximum number of UEs based on each UE's geographic location within the network comprises allocating the different resource blocks in the time period to a different maximum number of UEs.

20. The method of claim 1, wherein the allocating the given resource block further comprises:
selecting the given resource block used by a UE in a cell based on the channel quality indicator (CQI) of the UE.

21. The method of claim 20, wherein the allocating the given resource block further comprises:
estimating total transmit power of the UEs allocated to the given resource block; and
providing feedback, based on the estimate of total transmit power of the UEs to base stations in the LTE network, to adjust the number of UEs allocated to the given resource block.

22. The method of claim 21, wherein the estimating and providing feedback are performed by a controller.

23. The method of claim 22, wherein the controller comprises a network power controller associated with all base stations in the LTE network.

24. The method of claim 22, wherein the controller comprises a central power controller associated with base stations in a geographic region within the LTE network.

25. A controller for allocating resource blocks across a Long Term Evolution (LTE) network, wherein the controller is in communication with base stations in the LTE network, and the controller is configured to perform operations comprising:
determining a maximum number of user equipments (UEs) in the LTE network that are permitted to transmit in a time period using a given resource block, according to an upper limit on the overall transmission power in the LTE network for the given resource block; and
allocating the given resource block in the time period to up to the maximum number of UEs based on each UE's geographic location within the network.

26. The controller of claim 25, wherein determining the maximum number of UEs that are permitted to transmit comprises:
selecting a transmit power level for each of the up to the maximum number of UEs such that a sum of the transmit power levels does not exceed the maximum aggregate transmit power.

27. The controller of claim 26, wherein the UEs transmitting using the given resource block in the time period are associated with multiple base stations.

28. The controller of claim 25, wherein in the time period, each resource block is allocated to a maximum of one UE per cell.

29. The controller of claim 25, wherein each UE that is permitted to transmit is associated with one or more resource blocks in the time period.

30. The controller of claim 25, configured to perform operations further comprising:
allocating, during the time period, the given resource block to up to the maximum number of UEs each having the geographic location in a geographic region within the network.

31. The controller of claim 30, wherein the time period is a first time period, and wherein the geographic region is a first geographic region, the controller configured to perform operations further comprising:
allocating, during a second time period, the given resource block to up to the maximum number of UEs each having the geographic location in a second geographic region within the network,
wherein the second geographic region is different from the first geographic region.

32. The controller of claim 26, wherein determining maximum number of UEs comprises determining the maximum aggregate transmit power for the given resource block based on a power mask that is independent of the given resource block.

33. The controller of claim 32, wherein selecting a transmit power level for each of the up to the maximum number of UEs comprises selecting transmit power levels of the UEs that follow a Gaussian distribution.

34. The controller of claim 33, wherein determining a maximum number of UEs that are permitted to transmit in a time period using the given resource block comprises selecting a deterministic maximum number of UEs to be scheduled over the LTE network.

35. The controller of claim 33, wherein determining a maximum number of UEs that are permitted to transmit in a time period using the given resource block comprises selecting a randomly distributed maximum number of UEs to be scheduled over the LTE network.

36. The controller of claim 35, wherein determining a maximum number of UEs that are permitted to transmit in a time period using the given resource block comprises selecting an average value of a Poisson distributed maximum number of UEs to be scheduled over the LTE network.

37. The controller of claim 26, wherein the determining the maximum number of UEs for the given resource block comprises determining the maximum aggregate transmit power for the given resource block based on a power mask that is dependent on the given resource block.

38. The controller of claim 37, wherein selecting a transmit power level for each of the up to the maximum number of UEs comprises selecting transmit power levels of the UEs that follow a Gaussian distribution.

39. The controller of claim 38, wherein determining a maximum number of UEs that are permitted to transmit in a time period using the given resource block comprises selecting a deterministic maximum number of UEs to be scheduled over the LTE network.

40. The controller of claim 38, wherein determining a maximum number of UEs that are permitted to transmit in a time period using the given resource block comprises selecting a randomly distributed maximum number of UEs to be scheduled over the LTE network.

41. The controller of claim 40, wherein determining a maximum number of UEs that are permitted to transmit in a time period using the given resource block comprises selecting an average value of a Poisson distributed maximum number of UEs to be scheduled over the LTE network.

42. The controller of claim 25,
wherein the resource blocks in the LTE network each includes twelve subcarriers in a frequency domain across at least one time slot, and
wherein the time period is a time slot of fixed duration.

43. The controller of claim 35,
wherein determining the maximum number of UEs that are permitted to transmit in the time period using the given resource block comprises determining different maximum numbers of UEs that are permitted to transmit using different resource blocks during the time period, and
wherein allocating the given resource block in the time period to up to the maximum number of UEs based on each UE's geographic location within the network comprises allocating the different resource blocks in the time period to a different maximum number of UEs.

44. The controller of claim 25, wherein the allocating the given resource block further comprises:
selecting the given resource block used by a UE in a cell based on the channel quality indicator (CQI) of the UE.

45. The controller of claim 44, wherein the allocating the given resource block further comprises:
estimating total transmit power of the UEs allocated to the given resource block; and
providing feedback, based on the estimate of total transmit power of the UEs to base stations in the LTE network, to adjust the number of UEs allocated to the given resource block.

46. The controller of claim 45, wherein the controller comprises a network power controller associated with all base stations in the LTE network.

47. The controller of claim 45, wherein the controller comprises a central power controller associated with base stations in a geographic region within the LTE network.

48. The controller of claim 25 in combination with the base stations.

49. A base station that is configured to communicate with the controller of claim 25.

50. A UE that is configured to use the resource blocks that are allocated by the method of claim 1.

51. A UE that is configured to communicate with the controller of claim 25.
